(19) United States
(12) Patent Application Publication
(10) Pub. No.: US 2026/0022595 A1
(43) Pub. Date: Jan. 22, 2026

(54) Door Handle Assembly for Vehicle Door and Method for Operating Same

(71) Applicant: Illinois Tool Works Inc., Glenview, IL (US)

(72) Inventor: Gang Yu, Shanghai (CN)

(21) Appl. No.: 19/276,328

(22) Filed: Jul. 22, 2025

(30) Foreign Application Priority Data
Jul. 22, 2024 (CN) 202410986135.3

(51) Int. Cl. E05B 85/10

(52) U.S. Cl. CPC E05B 85/107

(57) ABSTRACT

A door handle assembly for a vehicle door having a door surface includes a handle seat, a handle, a driving device, a handle shaft and a transmission device. The handle has a retracted position and a deployed position. The handle is flush with the door surface when the handle is in the retracted position, and the handle protrudes outwardly relative to the door surface when the handle is in the deployed position. The handle shaft is configured to rotate under the drive of the driving device. The transmission device connects the handle shaft to the handle, such that the handle is movable under the drive of the handle shaft between the retracted position and the deployed position relative to the handle seat. The driving device is configured such that when the handle is in the retracted position or in the deployed position, the driving device is activated in response to the rotation of the handle shaft by a preset angle when the handle is pushed by an operator, so as to deploy or retract the handle.

### RELATED APPLICATION

The present application claims the benefit of Chinese Patent Application No. 202410986135.3, filed Jul. 22, 2024, titled “Door Handle Assembly for Vehicle Door and Method for Operating Same,” the contents of which are hereby incorporated by reference.

### TECHNICAL FIELD

The present disclosure relates to a door handle assembly, and in particular to a door handle assembly for a vehicle door and a method for operating the door handle assembly.

### BACKGROUND

A door handle assembly of a vehicle, for example an outer door handle assembly, is designed to be grasped by an operator to open a door, unlock the door, etc. For this purpose, a handle of the door handle assembly of the vehicle can extend beyond a door surface, such that the operator can grasp the handle for the above operations.

### SUMMARY

The present disclosure relates generally to a door handle assembly, substantially as illustrated by and described in connection with at least one of the figures, as set forth more completely in the claims.

### DESCRIPTION OF THE DRAWINGS

The foregoing and other objects, features, and advantages of the devices, systems, and methods described herein will be apparent from the following description of particular examples thereof, as illustrated in the accompanying figures, where like or similar reference numbers refer to like or similar structures. The figures are not necessarily to scale, emphasis instead being placed upon illustrating the principles of the devices, systems, and methods described herein.

FIG. 1A is a front perspective view of a door handle assembly according to an embodiment of the present disclosure.

FIG. 1B is a rear perspective view of the door handle assembly shown in FIG. 1A.

FIG. 1C is a perspective view of a vehicle having the door handle assembly of FIG. 1A.

FIG. 1D is a top view of the door handle assembly shown in FIG. 1A, with a handle in a deployed position.

FIG. 1E is a top view of the door handle assembly of FIG. 1A, with the handle in a retracted position.

FIG. 2A is a front exploded view of the door handle assembly shown in FIG. 1A, with a rear cover removed.

FIG. 2B is a rear exploded view of the door handle assembly shown in FIG. 1A, with the rear cover removed.

FIG. 3A is a rear view of the door handle assembly shown in FIG. 1A, with the rear cover removed.

FIG. 3B is a cross-sectional view taken along line B-B of FIG. 3A.

FIG. 3C is a cross-sectional view along line C-C of FIG. 3A.

FIG. 4A is a cross-sectional view of the door handle assembly shown in FIG. 1A, with the handle in the retracted position.

FIG. 4B is a cross-sectional view of the door handle assembly shown in FIG. 1A, with the handle in a deployment trigger position.

FIG. 4C is a cross-sectional view of the door handle assembly shown in FIG. 1A, with the handle is in the deployed position.

FIG. 4D is a cross-sectional view of the door handle assembly shown in FIG. 1A, with the handle in a retraction trigger position.

FIG. 5 is a block diagram of elements of the door handle assembly in communication with a control device according to an embodiment of the present disclosure.

FIG. 6 is a flowchart for deploying and retracting a handle according to an embodiment of the present disclosure.

FIG. 7 is a block diagram of an embodiment of the control device.

### DETAILED DESCRIPTION

References to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context. Recitation of ranges of values herein are not intended to be limiting, referring instead individually to any and all values falling within and/or including the range, unless otherwise indicated herein, and each separate value within such a range is incorporated into the specification as if it were individually recited herein. In the following description, it is understood that terms such as “first,” “second,” “top,” “bottom,” “side,” “front,” “back,” and the like are words of convenience and are not to be construed as limiting terms. For example, while in some examples a first side is located adjacent or near a second side, the terms “first side” and “second side” do not imply any specific order in which the sides are ordered.

The terms “about,” “approximately,” “substantially,” or the like, when accompanying a numerical value, are to be construed as indicating a deviation as would be appreciated by one of ordinary skill in the art to operate satisfactorily for an intended purpose. Ranges of values and/or numeric values are provided herein as examples only, and do not constitute a limitation on the scope of the disclosure. The use of any and all examples, or exemplary language (“e.g.,” “such as,” or the like) provided herein, is intended merely to better illuminate the disclosed examples and does not pose a limitation on the scope of the disclosure. The terms “e.g.,” and “for example” set off lists of one or more non-limiting examples, instances, or illustrations. No language in the specification should be construed as indicating any unclaimed element as essential to the practice of the disclosed examples.

The term “and/or” means any one or more of the items in the list joined by “and/or.” As an example, “x and/or y” means any element of the three-element set {(x), (y), (x, y)}. In other words, “x and/or y” means “one or both of x and y”. As another example, “x, y, and/or z” means any element of the seven-element set {(x), (y), (z), (x, y), (x, z), (y, z), (x, y, z)}. In other words, “x, y, and/or z” means “one or more of x, y, and z.”

According to a first aspect of the present disclosure, the present disclosure provides a door handle assembly for a vehicle door having a door surface, the door handle assembly includes a handle seat, a handle, a driving device, a handle shaft and a transmission device. The handle has a retracted position and a deployed position. The handle is flush with the door surface when the handle is in the retracted position, and the handle protrudes outwardly relative to the door surface when the handle is in the deployed position. The handle shaft is configured to rotate under the drive of the driving device. The transmission device connects the handle shaft to the handle, such that the handle is movable under the drive of the handle shaft between the retracted position and the deployed position relative to the handle seat. The driving device is configured such that when the handle is in the retracted position or in the deployed position, the driving device is activated in response to the rotation of the handle shaft by a preset angle when the handle is pushed by an operator, so as to deploy or retract the handle.

According to the door handle assembly in the first aspect of the present disclosure, the handle shaft is fixedly connected to an output end of the driving device.

According to the door handle assembly in the first aspect of the present disclosure, the handle is slidably mounted on the handle seat.

According to the door handle assembly in the first aspect of the present disclosure, one of the handle and the handle seat is provided with a sliding groove thereon, while the other of the handle and the handle seat is provided with a slider thereon. The slider cooperates with the sliding groove to enable the slidable mounting of the handle on the handle seat.

According to the door handle assembly in the first aspect of the present disclosure, the transmission device includes at least one connecting arm and at least one push rod. The at least one connecting arm is fixedly connected to the handle shaft at a proximal end thereof. The at least one push rod is pivotally connected to the handle at a proximal end thereof, and the at least one push rod is pivotally connected at a distal end thereof to a distal end of the at least one connecting arm.

According to the door handle assembly in the first aspect of the present disclosure, the at least one connecting arm includes two connecting arms, the two connecting arms are respectively close to two opposite ends of the handle shaft. The at least one push rod includes two push rods, the two push rods are respectively connected to the two connecting arms.

According to the door handle assembly in the first aspect of the present disclosure, the handle seat is provided with at least one limiting inclined surface, the limiting inclined surface is configured to come into contact with the at least one connecting arm when the handle reaches the deployed position, so as to retain the handle in the deployed position.

According to the door handle assembly in the first aspect of the present disclosure, the door handle assembly further includes a sensor, the sensor is provided on the at least one limiting inclined surface. The at least one connecting arm is configured such that the at least one connecting arm applies a pressure to the sensor when a pulling force is applied to the handle in the deployed position, to cause the sensor to generate a sensing signal for opening a door lock of the vehicle.

According to the door handle assembly in the first aspect of the present disclosure, it further includes a control device. The control device is communicatively connected to the driving device and configured to control the driving device to rotate in a first rotating direction so as to deploy the handle or to rotate in a second rotating direction opposite to the first rotating direction so as to retract the handle.

According to a second aspect of the present disclosure, the present disclosure provides a method for operating a door handle assembly mounted in a vehicle door, the method includes the following steps: (a) detecting a signal indicating that a handle of the door handle assembly is pushed by a preset distance; (b) determining, if the signal indicating that the handle is pushed by the preset distance is detected, whether the handle is in a retracted position or in a deployed position, and performing step (c) if it is detected that the handle is in the retracted position, or performing step (d) if it is detected that the handle is in the deployed position; (c) activating a driving device to rotate in a first rotating direction so as to deploy the handle; and (d) activating the driving device to rotate in a second rotating direction opposite to the first rotating direction so as to retract the handle.

According to the method in the second aspect of the present disclosure, the signal indicating that the handle is pushed by the preset distance in the step (a) is detected by detecting that an output end of the driving device is rotated by a preset angle in the second rotating direction.

According to the method in the second aspect of the present disclosure, during performing of the step (c), if a stall signal of the driving device is detected, the driving device is controlled to rotate in the second rotating direction so as to retract the handle; or during performing of the step (d), if the stall signal of the driving device is detected, the driving device is controlled to deploy the handle.

According to a third aspect of the present disclosure, the present disclosure provides a door handle assembly for a vehicle door having a door surface, the door handle assembly includes a handle seat, a handle, a handle shaft and a transmission device. The handle is slidably mounted on the handle seat and has a retracted position and a deployed position. The handle is flush with the door surface of a vehicle when the handle is in the retracted position, and the handle protrudes outwardly relative to the door surface when the handle is in the deployed position. The handle shaft is configured to rotate under the drive of the driving device. The transmission device connects the handle shaft to the handle in such a way that the handle is slidable, under the drive of the handle shaft, between the retracted position and the deployed position relative to the handle seat.

According to the door handle assembly in the third aspect of the present disclosure, one of the handle and the handle seat is provided with a sliding groove thereon, while the other of the handle and the handle seat is provided with a slider thereon, wherein the slider cooperates with the sliding groove to enable the slidable mounting of the handle on the handle seat.

According to the door handle assembly in the third aspect of the present disclosure, the transmission device includes at least one connecting arm and at least one push rod. The at least one connecting arm is fixedly connected to the handle shaft at a proximal end thereof. The at least one push rod pivotally is connected to the handle at a proximal end thereof, and the at least one push rod is pivotally connected at a distal end thereof to a distal end of the at least one connecting arm.

According to the door handle assembly in the third aspect of the present disclosure, the handle seat is provided with at least one limiting inclined surface configured to come into contact with the at least one connecting arm when the handle reaches the deployed position, so as to retain the handle in the deployed position.

According to the door handle assembly in the third aspect of the present disclosure, the handle shaft is fixedly connected to an output end of the driving device.

According to a fourth aspect of the present disclosure, the present disclosure provides a door handle assembly for a vehicle door having a door surface, the door handle assembly includes a handle seat, a handle, a handle shaft, at least one connecting arm and at least one push rod. The handle is slidably mounted on the handle seat and has a retracted position and a deployed position. The handle is flush with the door surface of a vehicle when the handle is in the retracted position, and the handle protrudes outwardly relative to the door surface when the handle is in the deployed position. The handle shaft is configured to rotate under the drive of the driving device. The at least one connecting arm is fixedly connected to the handle shaft at a proximal end thereof. The at least one push rod is pivotally connected to the handle at a proximal end thereof, and the at least one push rod is pivotally connected at a distal end thereof to a distal end of the at least one connecting arm.

According to the door handle assembly in the fourth aspect of the present disclosure, one of the handle and the handle seat is provided with a slider thereon, while the other of the handle and the handle seat is provided with a sliding groove thereon. The slider cooperates with the sliding groove to enable the slidable mounting of the handle on the handle seat.

According to the door handle assembly in the fourth aspect of the present disclosure, the handle shaft is fixedly connected to an output end of the driving device.

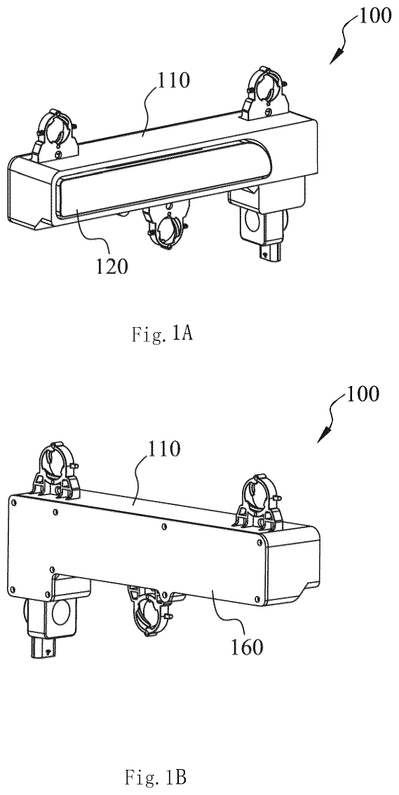

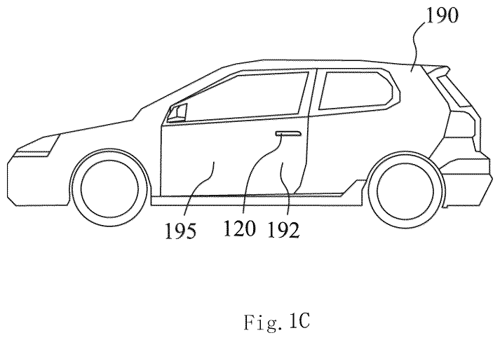

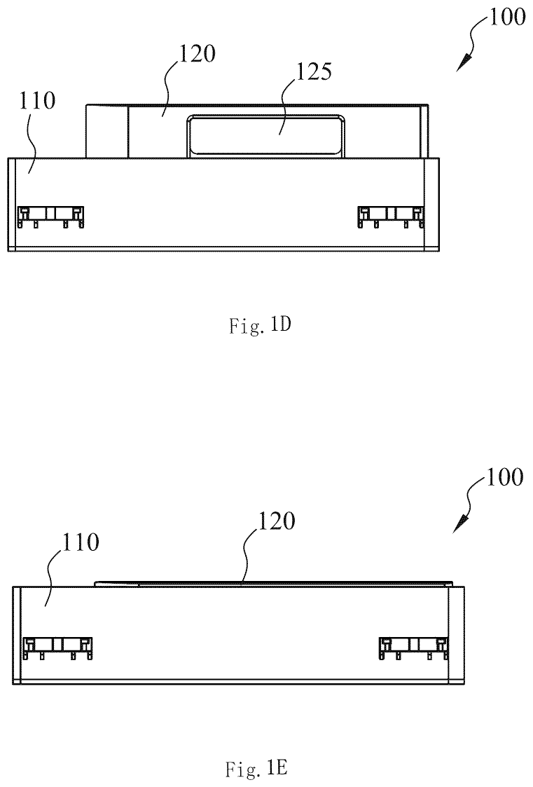

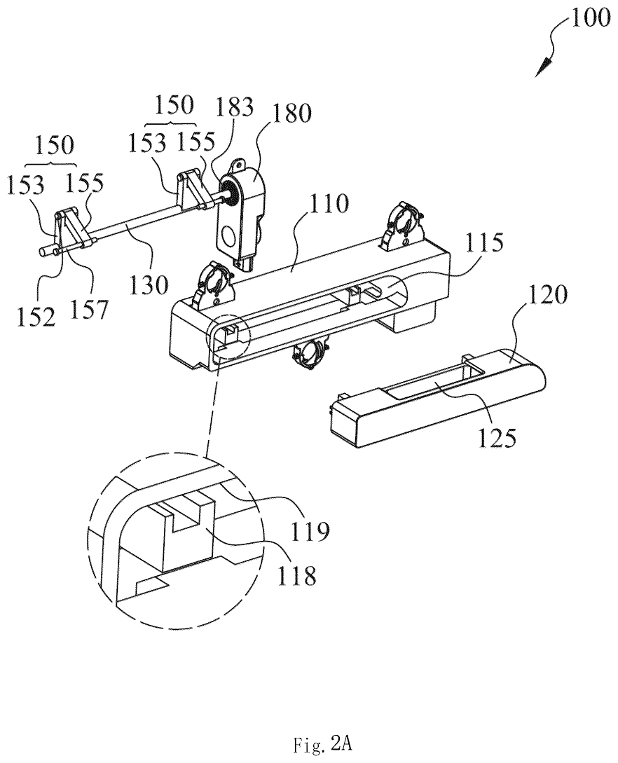

FIGS. 1A and 1B show an overall structure of a door handle assembly 100 according to an embodiment of the present disclosure, where FIG. 1A is a front perspective view of the door handle assembly 100, and FIG. 1B is a rear perspective view of the door handle assembly 100. As shown in FIGS. 1A and 1B, the door handle assembly 100 is a hidden door handle assembly that includes a handle seat 110, a handle 120, and a handle rear cover 160. The handle 120 is mounted on the handle seat 110 from a front side of the handle seat 110, and a rear side of the handle seat 110 is closed by the rear cover 160. The handle 120 is movable relative to the handle seat 110 and thus has a retracted position and a deployed position.

FIG. 1C shows a perspective view of a vehicle 190 having the door handle assembly 100 of FIG. 1A. As shown in FIG. 1C, the vehicle 190 has a door 192, the door 192 has an outer door surface 195, and the handle seat 110 is accommodated in the door 192 and is not visible in FIG. 1C. When the handle 120 is in the retracted position, the handle 120 is flush with the outer door surface 195 of the vehicle, and the handle 120 is thus hidden in the door 192 and the operator cannot pull the handle 120. When the handle 120 is in the deployed position, the handle 120 projects outwardly relative to the outer door surface 195 of the vehicle so as to allow the operator to pull the handle 120. In addition to the deployed position, the handle 120 may have other non-retracted positions, such as an unlock position in which the handle projects further outwardly relative to the door 192 than in the deployed position. In the unlock position, the handle can trigger unlocking of a door lock of the vehicle. In other embodiments, the door handle assembly according to embodiments of the present disclosure may also be used in a situation where the door is opened from inside of the door, with the handle being flush with an inner door surface.

FIGS. 1D and 1E show two states of the handle 120, where FIG. 1D is a top view of the door handle assembly 100 with the handle 120 in the deployed position, and FIG. 1E is a top view of the door handle assembly 100 with the handle 120 in the retracted position. As shown in FIG. 1D, the handle 120 is formed with a grip portion 125. When the handle 120 is in the deployed position, the grip portion 125 protrudes from the handle seat 110, and the operator can extend his hand into the grip portion 125 to pull the handle 120. As shown in FIG. 1E, when the handle 120 is in the retracted position, the handle 120, except for its portion flush with the outer door surface 195 of the vehicle, is accommodated in the handle seat 110.

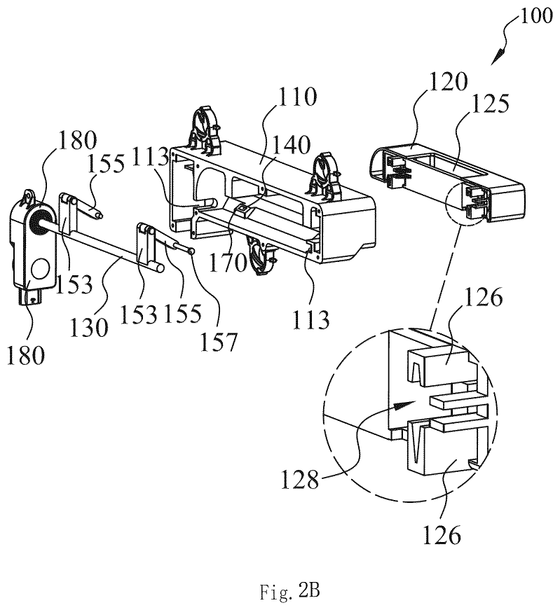

FIGS. 2A and 2B show a detailed structure of the handle assembly 100 with a front exploded view and a rear exploded view of the door handle assembly 100, respectively, and the rear cover 160 is not shown in FIGS. 2A and 2B for ease of illustration. As shown in FIGS. 2A and 2B, in addition to the handle seat 110, the handle 120, and the rear cover 160 not shown in FIGS. 2A and 2B, the door handle assembly 100 further includes a driving device 180, a handle shaft 130, and a transmission device 150. The driving device 180 is, for example, a motor or an actuator including a motor. The handle shaft 130 is fixedly connected to an output end 183 of the driving device 180 at one end thereof so as to rotate under the drive of the driving device 180. The handle shaft 130 is also connected to the handle 120 via the transmission device 150 such that the handle 120 can move between the retracted position and the deployed position under the action of the handle shaft 130.

The handle 120 is slidably mounted on the handle seat 110, such that when the handle 120 is moved between the retracted position and the deployed position, the handle 120 slides relative to the handle seat 110. In the embodiment shown in FIGS. 2A and 2B, the handle seat 110 is provided with an accommodating cavity 115, and a pair of cantilevered sliders 118 are arranged inside the accommodating cavity 115 (as shown in the enlarged partial view of a part in the dashed box in FIG. 2A) at a distance from a top surface 119 of the accommodating cavity 115. The pair of sliders 118 are arranged along a length direction of the handle seat 110 adjacent to left and right sides of the handle seat 110, and extend in a direction from a rear side to a front side of the handle seat 110. An end of the slider 118 close to the rear side of the handle seat 110 is connected to the handle seat 110, and the end close to the front side of the handle seat 110 is free. The handle 120 is provided with a pair of sliding grooves 128, and the pair of sliding grooves 128 are provided for cooperating with the pair of sliders 118 on the handle seat 110, respectively, to achieve slidable mounting of the handle 120 on the handle seat 110. As shown in the enlarged partial view of a part in the dashed box in FIG. 2B, each sliding groove 128 is formed by a pair of spaced-apart cantilevered beams 126 provided on the handle 120, with a spacing between the beams 126 forming the sliding groove 128. The arrangement of the sliding grooves 128 and the sliders 118 does not affect the accommodating of the handle 120 in the handle seat 110 as shown in FIG. 1E. In other embodiments, sliding grooves may be provided in the handle seat 110 while sliders may be provided on the handle 120, as long as the slidable mounting of the handle 120 on the handle seat 110 can be achieved.

Still as shown in FIGS. 2A and 2B, the transmission device 150 includes a pair of connecting arms 153 and a pair of push rods 155. Proximal ends of the pair of connecting arms 153 are fixedly connected to the handle shaft 130, distal ends of the pair of connecting arms 153 are pivotally connected to distal ends of the pair of push rods 155 by means of first connecting pins 152, respectively, and proximal ends of the pair of push rods 155 are pivotally connected to the handle 120 by means of second connecting pins 157. The pair of connecting arms 153 are, for example, formed integrally with the handle shaft 130, or may be fixedly connected to the handle shaft 130 in other ways. The pair of connecting arms 153 are located adjacent to opposite ends of the handle shaft 130, respectively, and extend substantially perpendicular to the handle shaft 130. By means of the relative rotations of the connecting rods 155, the connecting arms 153 and the handle 120, the handle shaft 130 can drive the handle 120 to slide relative to the handle seat 110. Furthermore, when the handle 120 is in the retracted position and the deployed position, the transmission device 150 including the connecting rods 155 and the connecting arms 153 can also drive the handle shaft 130 to rotate when the operator pushes the handle 120 inwardly, so as to drive the output end 183 of the driving device 180 to rotate, thereby triggering the activation of the driving device 180 to perform the action of deploying or retracting the handle, which will be described in detail below. In other embodiments, the transmission device 150 may also include other structures or components, instead of the push rods and the connecting arms, as long as the above function is achieved. Furthermore, in other embodiments, the numbers of connecting rods 155 and of connecting arms 153 are not limited to one pair, and may be one, or more than one pair, respectively.

As shown in FIG. 2B, a pair of limiting inclined surfaces 170 are provided at a bottom of the accommodating cavity 115 of the handle seat 110, and the limiting inclined surfaces 170 extend obliquely upwards toward the sliders 118 in a direction from the rear side to the front side of the handle seat 110. The limiting inclined surfaces 170 are configured such that when the handle reaches the deployed position, the pair of limiting inclined surfaces 170 come into contact with the pair of connecting arms 153, respectively, to block further rotation of the handle shaft 130, retaining the handle 120 in the deployed position. The door handle assembly 100 further includes a sensor 140 disposed on one of the pair of limiting inclined surfaces 170. The sensor 140 is configured to generate a sensing signal for unlocking the door lock of the vehicle. When a pull force is applied to the handle 120 in the deployed position, the connecting arms 153 can apply a sufficient pressure to the sensor 140 to cause the sensor to generate an unlock signal as mentioned above.

As still shown in FIG. 2B, a supporting portion 113 for supporting the handle shaft 130 in the handle seat 110 is further provided at the bottom of the accommodating cavity 115 of the handle seat 110. The supporting portion 113 is a pair of support slots spaced apart by a certain distance, and the two ends of the handle shaft 130 are accommodated in the support slots.

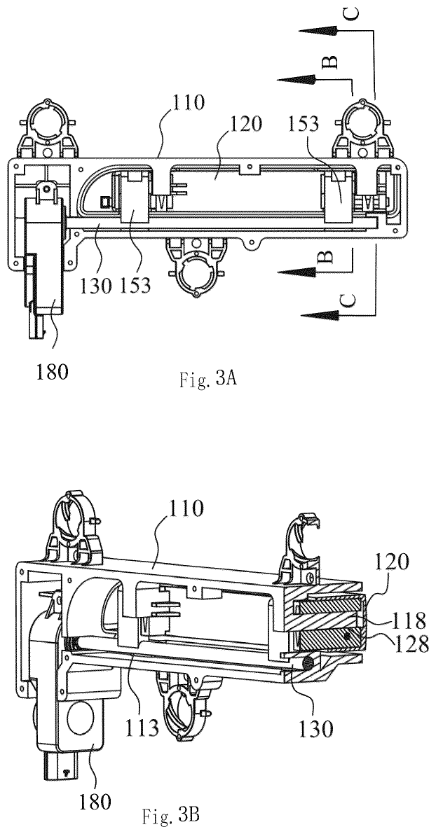

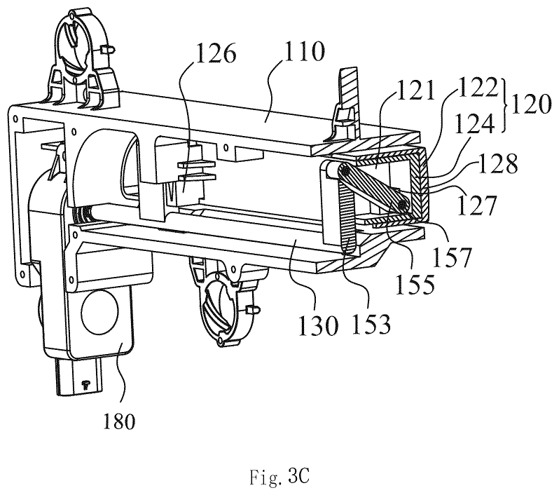

FIGS. 3A-3C show an assembly relationship between the components of the door handle assembly 100, where FIG. 3A is a rear view of the door handle assembly 100 shown in FIG. 1A, with the rear cover removed, FIG. 3B is a cross-sectional view taken along line B-B of FIG. 3A, and FIG. 3C is a cross-sectional view taken along line C-C of FIG. 3A. As shown in FIG. 3B, the handle shaft 130 is supported on the supporting portion 113 of the handle seat 110, and the sliders 118 of the handle seat 110 are inserted into the sliding grooves 128 of the handle 120.

As shown in FIG. 3C, the push rod 155 is pivotally connected to a connecting block 127 of the handle 120 by means of the second connecting pin 157. The handle 120 is of a two-piece structure including a handle housing 122 and a handle core 124 located inside the handle housing 122, where the handle core 124 defines the handle accommodating cavity 121, and the connecting block 127 connected to the push rod 155 is located at the bottom of the handle accommodating cavity 121. The beams 126 defining the sliding grooves 128 are partially located inside the handle accommodating cavity 121 and extend rearwardly from the handle accommodating cavity 121. The majority of the push rod 155 may also be accommodated in the handle accommodating cavity 121. A front side wall 128 of the handle housing 122 is configured to be flush with the door of the vehicle to “hide” the handle 120 in the door of the vehicle.

According to embodiments of the present disclosure, when the handle shaft 130 is rotated under the drive of the driving device 180, the connecting arms 153 are rotated therewith, and the rotation of the connecting arms 153 cause the push rods 155 pivotally connected thereto to rotate and move relative to the connecting arms 153, such that the push rods 155 drive the handle 120 to slide on the handle seat 110. Thereby, the handle 120 can be moved between the retracted position and the deployed position under the drive of the driving device 180. The driving device 180 drives the handle 120 to move from the retracted position to the deployed position when the handle shaft 130 is driven by the driving device 180 to rotate in a first rotating direction, and when the handle shaft 130 is driven by the driving device 180 to rotate in a second rotating direction opposite to the first rotating direction, the driving device 180 drives the handle from the deployed position to the retracted position.

Furthermore, according to embodiments of the present disclosure, when it is desired to deploy the handle 120 in the retracted position, and when it is desired to retract the handle 120 in the deployed position, the activation of the driving device 180 is triggered by the operator pushing the handle 120 to move and thus causing the handle shaft 130 to rotate. In particular, when the handle 120 is in the retracted position or the deployed position, if the operator applies a push force to the handle 120, the handle shaft 130 is driven by the handle 120 to rotate in the second rotating direction, and in response to that the handle shaft 130 rotates by a preset angle when the operator pushes the handle 120, the driving device 180 is activated to drive the handle shaft 130 to rotate, thereby retracting or deploying the handle. According to embodiments of the present disclosure, since the handle shaft 130 is connected to the output end 183 of the driving device 180, the handle shaft 130 rotating in the second rotating direction when the operator pushes the handle 120 causes the output end 183 of the driving device 180 to rotate in the second rotating direction, and by detecting that the output end 183 of the driving device 180 is rotated by a preset angle in the second rotating direction, it can be determined that the operator is triggering the deployment or retraction of the handle 120. According to embodiments of the present disclosure, the above preset angle ranges from 6-9 degrees. In order to rotate the handle shaft 130 by a preset angle of 6-8 degrees, the handle 120 is pushed by the operator to move by a distance of approximately 5 mm.

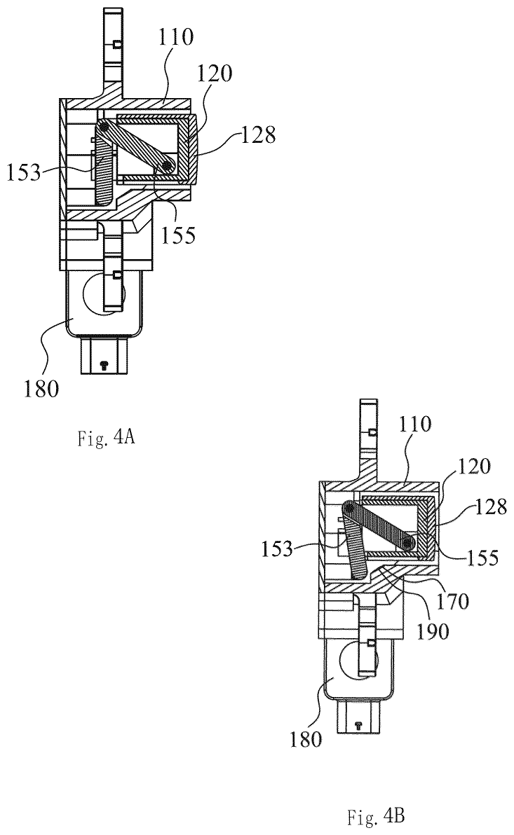

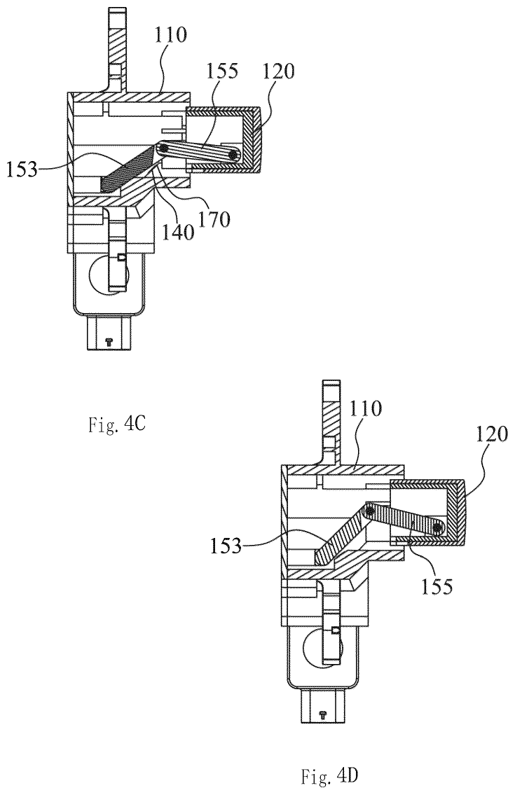

FIG. 4A is a cross-sectional view of the door handle assembly 100, with the handle 120 in the retracted position. As shown in FIG. 4A, when the handle 120 is in the retracted position, the handle 120 is accommodated inside the handle seat 110, and the front side wall 128 of the handle 120 is located outside the handle seat 110 and can be accessed by the operator. When it is desired to deploy the handle, the operator pushing the handle 120 inwardly by means of the front side wall 128 may trigger the activation of the driving device 180 to cause the driving device 180 to perform the operation of deploying the handle 120.

FIG. 4B is a cross-sectional view of the door handle assembly 100, with the handle 120 in a deployment trigger position. As shown in FIG. 4B, when the handle 120 is in the deployment trigger position, the handle 120 is retracted somewhat toward the interior of the handle seat 110 than in the retracted position shown in FIG. 4A, the connecting arm 153 is rotated in a counterclockwise direction (second rotating direction) by the preset angle (e.g. 6-9 degrees), the angle between the connecting arm 153 and the push rod 155 becomes smaller. Since the connecting arm 153 is fixedly connected to the handle shaft 130, the angle by which the connecting arm 153 rotates reflects the angle by which the handle shaft 130 rotate, both of which are identical. When the handle 120 is moved to the deployment trigger position, the driving device 180 is activated in response to the handle shaft 130 being rotated by the preset angle, and the operation of deploying the handle 120 is started.

FIG. 4C is a cross-sectional view of the door handle assembly 100, with the handle 120 in the deployed position. As shown in FIG. 4C, when the handle 120 is in the deployed position, the handle 120 is pushed out of the handle seat 110 by the connecting arm 153 and the push rod 155 to expose the grip portion 125. Therefore, when the handle 120 is in the deployed position, the operator can pull the handle by means of the grip portion 125 to perform the operations of unlocking, opening the door, etc. When the handle 120 is in the deployed position, the connecting arm 153 is rotated in a clockwise direction (first rotating direction) by an angle, and the angles between the connecting arm 153 and the push rod 155 become larger, as compared to the retracted position shown in FIG. 4A.

When unlocking is desired, the operator may pull the handle 120 in the deployed position outwardly, to cause the connecting arm 153 to continue to rotate in the clockwise direction (the first rotating direction) to press the sensor 140 on the limiting inclined surface 170. When the connecting arm 153 applies a sufficient pressure on the sensor 140, the sensor 140 generates a sensing signal to unlock the door lock of the vehicle, such that the operation of unlocking can be performed.

When it is desired to retract the handle, the operator may trigger the activation of the driving device 180 by pushing inwardly or pressing the handle 120 in the deployed position to cause the driving device 180 to perform the operation of retracting the handle 120.

FIG. 4D is a cross-sectional view of the door handle assembly 100, with the handle 120 in a retraction trigger position. As shown in FIG. 4D, when the handle 120 is in the retraction trigger position, the handle 120 is retracted somewhat toward the interior of the handle seat 110 than in the deployed position shown in FIG. 4C, the connecting arm 153 is rotated in the counterclockwise direction (the second rotating direction) by the preset angle (e.g. 6-9 degrees), the angle between the connecting arm 153 and the push rod 155 becomes smaller. Since the connecting arm 153 is fixedly connected to the handle shaft 130, the angle by which the connecting arm 153 rotates reflects the angle by which the handle shaft 130 rotate, both of which are identical. When the handle 120 is moved to the retraction trigger position, the driving device 180 is activated in response to the handle shaft 130 being rotated by the preset angle, and the operation of retracting the handle 120 is started.

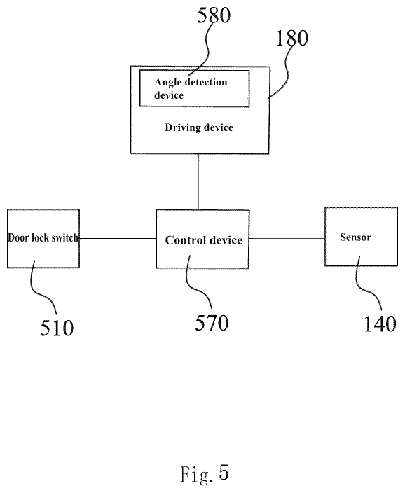

FIG. 5 is a block diagram of elements of the door handle assembly 100 in communication with a control device according to an embodiment of the present disclosure. As shown in FIG. 5, the door handle assembly 100 further includes a control device 570 and a door lock switch 510. The door lock switch 510, the driving device 180 and the sensor 140 are communicatively connected to the control device 570.

The driving device 180 is controlled by the control device 570 to rotate in either the first rotating direction or the second rotating direction. Furthermore, the control device 570 can monitor the driving device 180 and receive signals indicative of the direction of rotation and the angle of rotation of the output end 183 of the driving device 180. For example, when the driving device 180 is in its initial position (retracted position), an initial angle of its output end 183 is 0 degrees, and when the driving device 180 drives the handle 120 in the first rotating direction to the deployed position, the angle of rotation of the output end 183 is 60 degrees, and when the driving device 180 is rotated in the second rotating direction such that the handle 120 reaches the deployment trigger position, the output end 183 is rotated 6 to 9 degrees relative to the initial position, and when the driving device 180 is rotated in the second rotating direction such that the handle 120 reaches the retraction trigger position, the output end 183 is rotated 6-9 degrees relative to the deployed position.

To this end, the driving device 180 is provided with an angle detection device 580 for detecting or obtaining the angle of rotation of the output end 183 of the driving device 180. In some embodiments, the angle detection device 580, for example, includes a plurality of position sensors that can detect whether the output end 183 of the driving device 180 reaches the deployed position, the deployment trigger position, the retraction trigger position, etc., and send a detected signal to the control device 500. In some embodiments, the angle detection device 580 is for example an encoder, and the rotation angle of the output end 183 of the driving device 180 can be obtained by means of a pulse signal output by the encoder.

For the direction of rotation of the output end 183 of the driving device 180, if the output end 183 of the driving device 180 is controlled by the control device 500 to rotates, the control device 500 can obtain the information about the direction of rotation of the output end 183 of the driving device 180 from the direction of a control current. If the output end 183 of the driving device 180 is rotated in response to the handle shaft 130 being rotated by the preset angle when the operator pushes the handle 120, the driving device 180 generates a reverse excitation current, the control device 500 can obtain the information about the direction of rotation of the output end 183 of the driving device 180 from the direction of the reverse excitation current.

Furthermore, the sensor 140 can communicate with the control device 570 to send an unlock signal to the control device 570. The door lock switch 510 is controlled by the control device 570 to open, thereby unlocking the door lock.

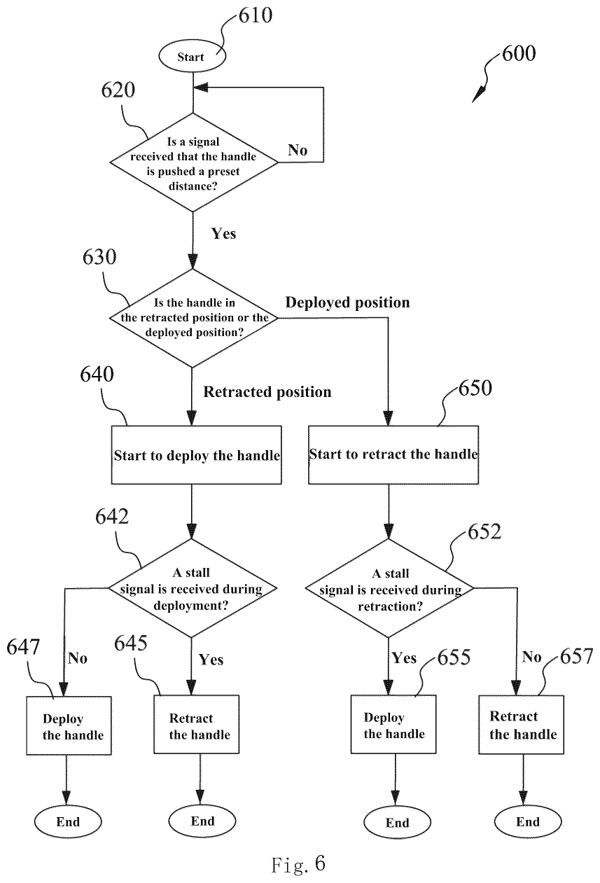

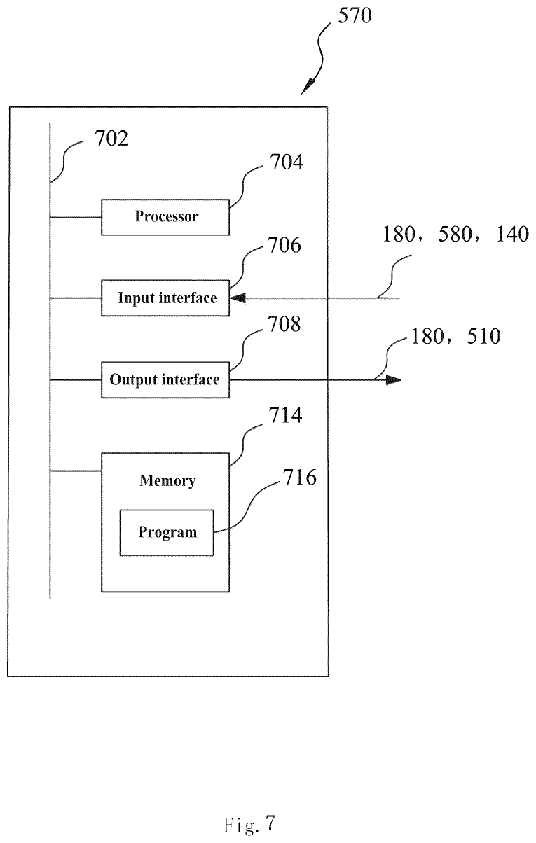

FIG. 6 is a flowchart for deploying and retracting the handle 120 according to an embodiment of the present disclosure. As shown in FIG. 6, in step 610, the control device 570 starts to operate. In step 620, the control device 570 monitors the driving device 180 to determine whether the handle is pushed a preset distance, and if not, the monitoring is continued, and if so, it proceeds to step 630. In step 630, the control device 570 determines whether the handle is in the retracted position or the deployed position to determine whether to perform the operation of deploying the handle or the operation of retracting the handle. If it is determined that the handle is in the retracted position, it proceeds to step 640, and if it is determined that the handle is in the deployed position, it proceeds to step 650.

In step 640, the control device 570 activates the driving device 180 such that the driving device 180 rotates in a direction for deploying the handle, so as to start the operation of deploying the handle. During the performance of the operation of deploying the handle by the driving device 180, the control device 570 monitors the driving device 180 to determine whether a stall signal of the driving device 180 is received. If the control device 570 receives the stall signal of the driving device 180, it proceeds to step 645. In step 645, the control device 570 controls the driving device 180 to change the rotating direction to retract the handle 120 to the retracted position. If the control device 570 receives no stall signal of the driving device 180, it proceeds to step 647. In step 647, the control device 570 controls the driving device 180 to continue the operation of deploying the handle until the handle reaches the deployed position.

In step 650, the control device 570 activates the driving device 180 such that the driving device 180 rotates in a direction for retracting the handle, so as to start the operation of retracting the handle. During the performance of the operation of retracting the handle by the driving device 180, the control device 570 monitors the driving device 180 to determine whether a stall signal of the driving device 180 is received. If the control device 570 receives the stall signal of the driving device 180, it proceeds to step 655. In step 655, the control device 570 controls the driving device 180 to change the rotating direction to deploy the handle 120 to the deployed position. If the control device 570 receives no stall signal of the driving device 180, it proceeds to step 657. In step 657, the control device 570 controls the driving device 180 to continue the operation of retracting the handle until the handle reaches the retracted position.

In the above step 620, the control device 570 determines that the handle 120 is pushed the preset distance by receiving a signal that the output end of the driving device 180 is rotated by a preset angle in the second rotating direction.

During the deployment and retraction of the handle 120 under the drive of the driving device 180, when a foreign object obstructs the handle 120 from further deployment or retraction, this may cause the driving device 180 to stall. The stall signal of the driving device 180 may be obtained, for example, by detecting whether the current of the driving device 180 exceeds a certain threshold value for a certain period of time. The handle assembly 100 of the present disclosure can detect the stall signal of the driving device 180 and control the driving device 180 to rotate reversely based on the stall signal, thereby preventing the driving device from still rotating in its original direction and pinching an object (such as a human hand) in the event that the handle is obstructed by the object. Therefore, the handle assembly 100 according to the present disclosure has an anti-pinch function.

Furthermore, the control device 570 of the handle assembly 100 according to the present disclosure is further configured to first determine whether the handle 120 is in a position between the retracted position and the deployed position from the information about the angle of rotation of the driving device 180 when the driving device 180 is de-energized and re-energized during operation, and if so, the handle 120 is moved to its initial position (retracted position) by the driving device 180 before subsequent operations are performed as required.

FIG. 7 is a block diagram of an embodiment of the control device 570. As shown in FIG. 7, the control device 570 includes a bus 702, a processor 704, an input interface 706, an output interface 708, and a memory 714 in which a program 716 is stored. Each of the processor 704, the input interface 706, the output interface 708, and the memory 714 is communicatively connected to the bus 702, such that the processor 704 can control the running of the input interface 706, the output interface 708 and the memory 714. The memory 714 is used to store programs, instructions and data. The processor 704 reads the programs, the instructions and the data from the memory 714, and can write data to the memory 714. The program 716 includes a program that implements the control flow described in FIG. 6. The input interface 706 is connected to the driving device 180 and its angle detection device 580 as well as the sensor 140, to obtain the signals indicative of the direction of rotation and the angle of rotation of the driving device 180 and to receive the sensing signals sent by the sensor 140 for unlocking. The output interface 708 is connected to the driving device 180 and the door lock switch 510 to send control signals to the driving device 180 and the door lock switch 510 to control the deployment or retraction of the handle 120 and to control the unlock of the door lock.

According to one aspect of the present disclosure, since the door handle assembly according to the present disclosure is provided with the handle shaft connected to the output end of the driving device and the handle, and the driving device is configured such that when the handle is in the retracted position or the deployed position, the driving device is activated in response to the handle shaft being rotated by the preset angle when the operator pushes the handle, no additional electronic elements (e.g. microswitches) for sensing the action of the operator to deploy or retract the handle and no additional buttons for deploying or retracting the handle need to be provided for the door handle assembly according to the present disclosure. Therefore, the door handle assembly according to the present disclosure allows for the deployment and retraction of the hidden door handle with fewer components and a more concise appearance.

According to another aspect of the present disclosure, in the door handle assembly according to the present disclosure, the structure for transmitting movements between the handle and the driving device is simplified, thus enabling the deployment and retraction of the hidden door handle to be achieved with a simpler mechanical configuration.

Any above-cited patents and patent publications are hereby incorporated by reference in their entirety. While the present method and/or system have been described with reference to certain implementations, it will be understood by those skilled in the art that various changes may be made, and equivalents may be substituted without departing from the scope of the present method and/or system. In addition, many modifications may be made to adapt a particular situation or material to the teachings of the present disclosure without departing from its scope. For example, block and/or components of examples disclosed may be combined, divided, re-arranged, and/or otherwise modified. Therefore, the present method and/or system are not limited to the particular implementations disclosed. Instead, the present method and/or system will include all implementations falling within the scope of the appended claims, both literally and under the doctrine of equivalents.

What is claimed is:

1. A door handle assembly for a vehicle door having a door surface, the door handle assembly comprising:
a handle seat;
a handle having a retracted position and a deployed position, wherein the handle is flush with the door surface when the handle is in the retracted position, and the handle protrudes outwardly relative to the door surface when the handle is in the deployed position;
a driving device;
a handle shaft being configured to rotate under the drive of the driving device; and
a transmission device connecting the handle shaft to the handle, such that the handle is movable under the drive of the handle shaft between the retracted position and the deployed position relative to the handle seat,
wherein the driving device is configured such that when the handle is in the retracted position or in the deployed position, the driving device is activated in response to the rotation of the handle shaft by a preset angle when the handle is pushed by an operator, so as to deploy or retract the handle.

2. The door handle assembly according to claim 1, wherein the handle shaft is fixedly connected to an output end of the driving device.

3. The door handle assembly according to claim 1, wherein the handle is slidably mounted on the handle seat.

4. The door handle assembly according to claim 3, wherein one of the handle and the handle seat is provided with a sliding groove thereon, while the other of the handle and the handle seat is provided with a slider thereon, wherein the slider cooperates with the sliding groove to enable the slidable mounting of the handle on the handle seat.

5. The handle assembly according to claim 1, wherein the transmission device comprises:
at least one connecting arm fixedly connected to the handle shaft at a proximal end thereof; and
at least one push rod pivotally connected to the handle at a proximal end thereof, the at least one push rod being pivotally connected at a distal end thereof to a distal end of the at least one connecting arm.

6. The door handle assembly according to claim 5,
wherein the at least one connecting arm comprises two connecting arms, the two connecting arms being respectively close to two opposite ends of the handle shaft; and
wherein the at least one push rod comprises two push rods, the two push rods being respectively connected to the two connecting arms.

7. The door handle assembly according to claim 5, wherein the handle seat is provided with at least one limiting inclined surface, the limiting inclined surface being configured to come into contact with the at least one connecting arm when the handle reaches the deployed position, so as to retain the handle in the deployed position.

8. The door handle assembly according to claim 7,
wherein the door handle assembly further comprises a sensor, the sensor being provided on the at least one limiting inclined surface; and
wherein the at least one connecting arm is configured such that the at least one connecting arm applies a pressure to the sensor when a pulling force is applied to the handle in the deployed position, to cause the sensor to generate a sensing signal for opening a door lock of the vehicle.

9. The door handle assembly according to claim 1, further comprising:
a control device being communicatively connected to the driving device and configured to control the driving device to rotate in a first rotating direction so as to deploy the handle or to rotate in a second rotating direction opposite to the first rotating direction so as to retract the handle.

10. A method for operating a door handle assembly mounted in a vehicle door, the method comprising the following steps:
(a) detecting a signal indicating that a handle of the door handle assembly is pushed by a preset distance;
(b) determining, if the signal indicating that the handle is pushed by the preset distance is detected, whether the handle is in a retracted position or in a deployed position, and performing step (c) if it is detected that the handle is in the retracted position, or performing step (d) if it is detected that the handle is in the deployed position;
(c) activating a driving device to rotate in a first rotating direction so as to deploy the handle; and
(d) activating the driving device to rotate in a second rotating direction opposite to the first rotating direction so as to retract the handle.

11. The method according to claim 10, wherein the signal indicating that the handle is pushed by the preset distance in the step (a) is detected by detecting that an output end of the driving device is rotated by a preset angle in the second rotating direction.

12. The method according to claim 10, wherein
during performing of the step (c), if a stall signal of the driving device is detected, the driving device is controlled to rotate in the second rotating direction so as to retract the handle; or
during performing of the step (d), if the stall signal of the driving device is detected, the driving device is controlled to deploy the handle.

13. A door handle assembly for a vehicle door having a door surface, the door handle assembly comprising:
a handle seat;
a handle being slidably mounted on the handle seat and having a retracted position and a deployed position, wherein the handle is flush with the door surface of a vehicle when the handle is in the retracted position, and the handle protrudes outwardly relative to the door surface when the handle is in the deployed position;
a handle shaft being configured to rotate under the drive of the driving device; and
a transmission device connecting the handle shaft to the handle in such a way that the handle is slidable, under the drive of the handle shaft, between the retracted position and the deployed position relative to the handle seat.

14. The door handle assembly according to claim 13, wherein one of the handle and the handle seat is provided with a sliding groove thereon, while the other of the handle and the handle seat is provided with a slider thereon, wherein the slider cooperates with the sliding groove to enable the slidable mounting of the handle on the handle seat.

15. The handle assembly according to claim 13, wherein the transmission device comprises:
at least one connecting arm fixedly connected to the handle shaft at a proximal end thereof; and
at least one push rod pivotally connected to the handle at a proximal end thereof, and the at least one push rod being pivotally connected at a distal end thereof to a distal end of the at least one connecting arm.

16. The door handle assembly according to claim 15, wherein the handle seat is provided with at least one limiting inclined surface configured to come into contact with the at least one connecting arm when the handle reaches the deployed position, so as to retain the handle in the deployed position.

17. The door handle assembly according to claim 13, wherein the handle shaft is fixedly connected to an output end of the driving device.
